(19) United States
(12) Patent Application Publication
(10) Pub. No.: US 2016/0055805 A1
(43) Pub. Date: Feb. 25, 2016

(54) LIGHTING DEVICE, IMAGE DISPLAY DEVICE, AND CONTROL METHOD FOR LIGHTING DEVICE

(71) Applicant: CANON KABUSHIKI KAISHA, Tokyo (JP)

(72) Inventor: Makoto Onogi, Fujisawa-shi (JP)

(21) Appl. No.: 14/826,683

(22) Filed: Aug. 14, 2015

(30) Foreign Application Priority Data
Aug. 22, 2014 (JP) 2014-169636

(51) Int. Cl. G09G 3/34

(52) U.S. Cl. CPC G09G 3/3406; G09G 2320/062; G09G 2320/064; G09G 2320/0646; G09G 2330/023

(57) ABSTRACT

A lighting device includes a plurality of light sources corresponding to a plurality of areas of a screen, and a control unit configured to control at least one of a duty ratio between a lighting period and an light-out period and a drive current amount of each of the light sources based on input image data. The control unit controls lighting timings of the light sources in accordance with the drive current amounts of the light sources such that a fluctuation of the total of the drive current amounts of the light sources is suppressed.

### BACKGROUND OF THE INVENTION

1. Field of the Invention

The present invention relates to a lighting device, an image display device, and a control method for the lighting device.

2. Description of the Related Art

In an image display device (liquid crystal display) that uses a liquid crystal panel, the liquid crystal panel is not a self-luminous device, and hence a backlight that uses a light source such as a light-emitting diode (LED) or the like is used. In addition, as a method for adjusting the brightness of an image in the liquid crystal display, there is used a method that changes the brightness of the backlight, and it is possible to increase a contrast ratio to a level higher than that in the case where the adjustment is performed only by controlling the transmittance of the liquid crystal. As the method for adjusting the brightness of the backlight, pulse width modulation (PWM) is often used. This method involves lighting and extinguishing the backlight at specific intervals and adjusting the brightness of the backlight by changing a ratio between a lighting period and a light-out period (duty ratio).

In the backlight that uses the LED as the light source, a large number of the LEDs are spread, and the entire screen is divided into several lighted areas (see FIGS. 2A and 2B) and PWM control is performed on each lighted area. Herein, when the lighting and the light-out (extinction) are repeated at the same phase in all of the lighted area, the total current amount significantly fluctuates in one cycle of the PWM. In the case where the current amount significantly fluctuates, power consumption is increased due to a reduction in the conversion efficiency of a power supply during a large current period. In addition, since it is necessary to design a backlight power supply such that the backlight power supply can bear the significant fluctuation, it is feared that cost may be increased. To cope with this, in Japanese Patent Application Laid-open No. 2009-188135, a lighting start timing is equally shifted in each of the lighted areas, and a total drive current is thereby leveled out.

Incidentally, there exists a technique called local dimming in which the duty ratio of the PWM is changed on a per lighted area basis. The local dimming is a technique in which the brightness of the backlight is changed for each lighted area in the screen in accordance with the tone of a display image (see, e.g., Japanese Patent Application Laid-open No. 2001-142409). By performing the local dimming, it becomes possible to prevent leakage of light from the liquid crystal at the time of black display (what is called “black floating”), and increase the contrast ratio in the screen.

In the case where local dimming control is performed, the total drive current is not leveled out by the method in Japanese Patent Application Laid-open No. 2009-188135. To cope with this, as a technique for controlling the backlight such that the fluctuation of the total drive current is reduced in this case as well, there is a technique in which the phase of the PWM of each lighted area is changed in accordance with the duty ratio of each lighted area (see, e.g., Japanese Patent Application Laid-open No. 2013-232398).

In Japanese Patent Application Laid-open No. 2013-232398, the lighted areas are classified into groups each having the same or substantially the same duty ratio, and the lighting start timings are determined such that the lighting start timings in each group are apart from each other. For example, in a situation where the lighted area having the duty ratio of 50% and the lighted area having the duty ratio of 0% are present together, as shown in FIG. 9A, the lighting start timing is adjusted for each group, and the fluctuation of the total current is thereby suppressed.

### SUMMARY OF THE INVENTION

However, in the case where the drive current amount of the light source differs from one lighted area to another, it is not possible to suppress the fluctuation of the total current even by the method in Japanese Patent Application Laid-open No. 2013-232398 that performs phase determination based on the duty ratio. A description will be given by using the case where the drive current amount of the light source differs from one lighted area to another (the drive current of each of a lighted area 1, a lighted area 2, a lighted area 11, and a lighted area 12 is twice the drive current of each of the other lighted areas) as an example, as shown in FIG. 9B. In this case, the same duty ratio is used in all of the light sources, and hence the lighting start timings of all of the lighted areas are set so as to be shifted equally, and the total current cannot be leveled out. In addition, even when the duty ratios of the individual light sources are different from each other in the example in FIG. 9B, the method in Japanese Patent Application Laid-open No. 2013-232398 is based on the assumption that the total currents of the individual light sources are equal to each other, and hence, even when the phase of the PWM is changed according to the method in Japanese Patent Application Laid-open No. 2013-232398, the total current cannot be leveled out.

Thus, in the conventional art, even when the lighting phase of the PWM is changed based on the duty ratio on a per lighted area basis, there is a possibility that the fluctuation range of the total current is increased in the case where the current amount differs from one lighted area to another.

To cope with this, the present invention suppresses the fluctuation of the drive current of the light source even in the case where at least one of the duty ratio and the drive current amount differs from one lighted area to another in a lighting device having a plurality of the light sources.

A first aspect of the present invention is a lighting device including a plurality of light sources corresponding to a plurality of areas of a screen, and a control unit configured to control at least one of a duty ratio between a lighting period and a light-out period and a drive current amount of each of the light sources based on input image data, wherein the control unit controls lighting timings of the light sources in accordance with the drive current amounts of the light sources such that a fluctuation of the total of the drive current amounts of the light sources is suppressed.

A second aspect of the present invention is a control method for a lighting device including a plurality of light sources corresponding to a plurality of areas of a screen, including the steps of controlling at least one of a duty ratio between a lighting period and a light-out period and a drive current amount of each of the light sources based on input image data, and controlling lighting timings of the light sources in accordance with the drive current amounts of the light sources such that a fluctuation of the total of the drive current amounts of the light sources is suppressed.

According to the present invention, it is possible to suppress the fluctuation of the drive current of the light source even when both or at least one of the duty ratio and the drive current amount differs from one lighted area to another in the lighting device having a plurality of the light sources.

Further features of the present invention will become apparent from the following description of exemplary embodiments with reference to the attached drawings.

### BRIEF DESCRIPTION OF THE DRAWINGS

FIG. 1 is a block diagram showing the schematic configuration of an image display device according to first to third embodiments;

each of FIGS. 2A and 2B is a view showing an example of a lighted area division of a backlight;

each of FIGS. 3A and 3B is a view for explaining a delay determination process in the first embodiment (first operation example);

each of FIGS. 4A to 4C is a view for explaining the delay determination process in the first embodiment (second operation example);

each of FIGS. 5A to 5C is a view for explaining the delay determination process in the first embodiment (third operation example);

each of FIGS. 6A to 6L is a view for explaining the delay determination process in the second embodiment (fourth operation example);

each of FIGS. 7A to 7L is a view for explaining the delay determination process in the third embodiment (fifth operation example);

FIG. 8A is a flowchart and each of FIGS. 8B to 8F is an explanatory view of the delay determination process in the first to third embodiments; and

each of FIGS. 9A and 9B is a view for explaining problems of a conventional art.

### DESCRIPTION OF THE EMBODIMENTS

The present invention will be described with reference to embodiments. The embodiments described below are shown as examples to explain the present invention, and the present invention is not limited to the following embodiments. In the following embodiments, the description will be given by taking a transmission-type liquid crystal display device as an example, but the image display device is not limited to the transmission-type liquid crystal display device. The image display device may be any image display device as long as the image display device displays an image on a screen by modulating light from a light emitting device (lighting device). For example, the image display device may also be a reflection-type liquid crystal display device. In addition, the image display device may also be an MEMS shutter display that uses a micro electro mechanical system (MEMS) shutter instead of a liquid crystal element.

### First Embodiment

### Configuration

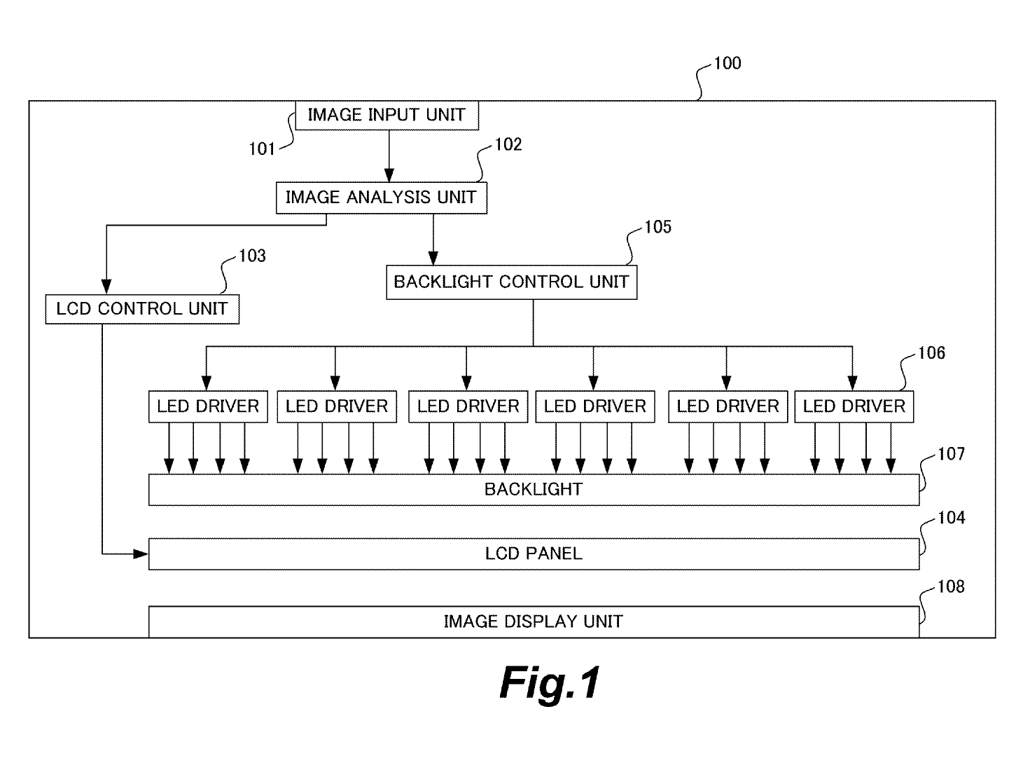

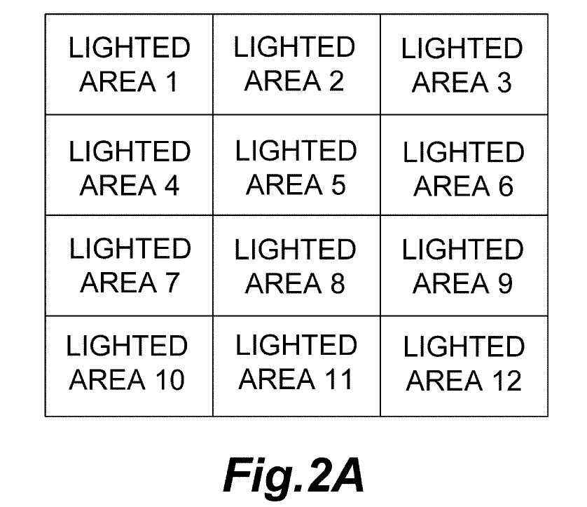

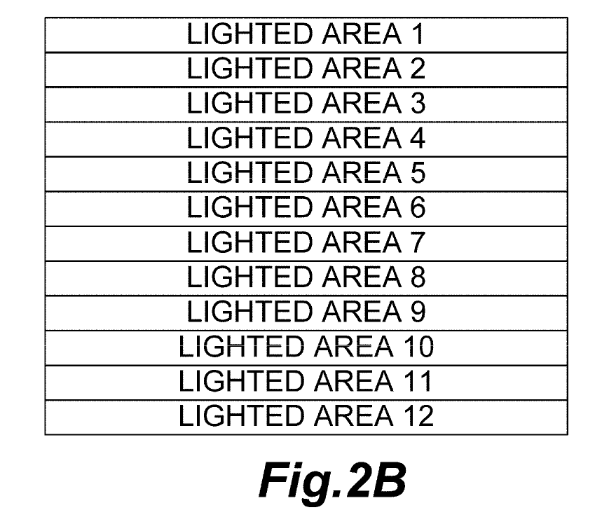

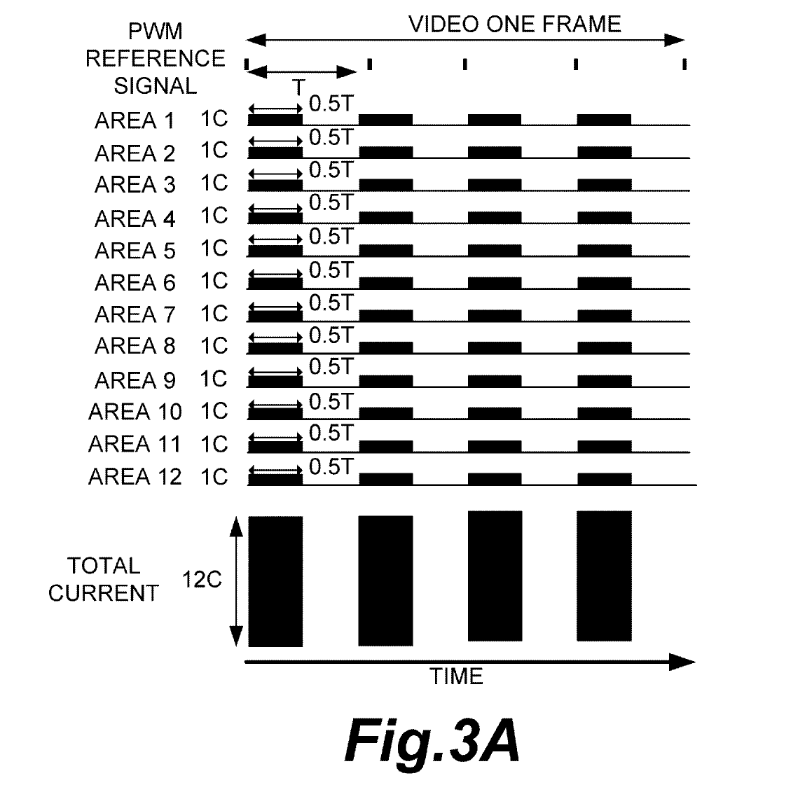

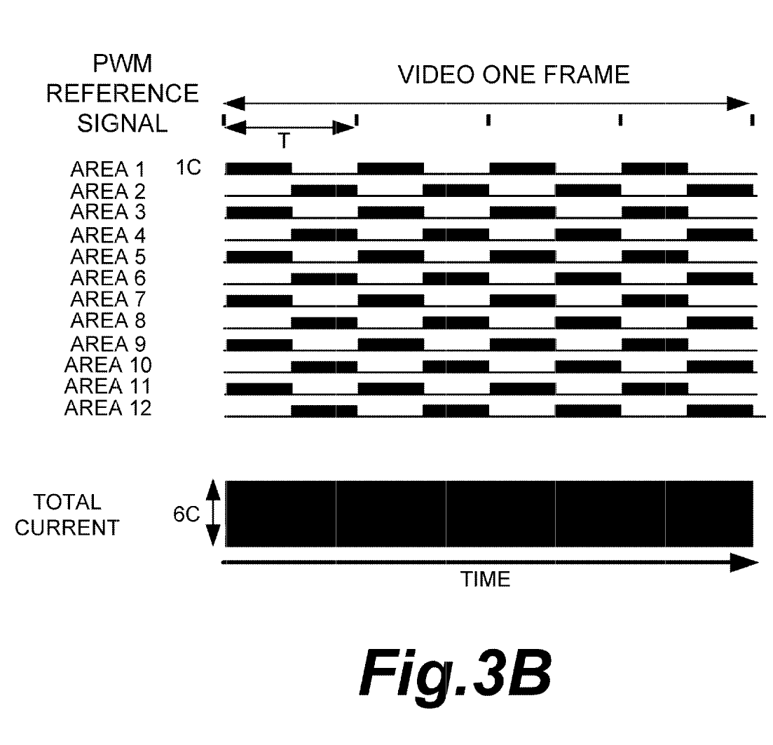

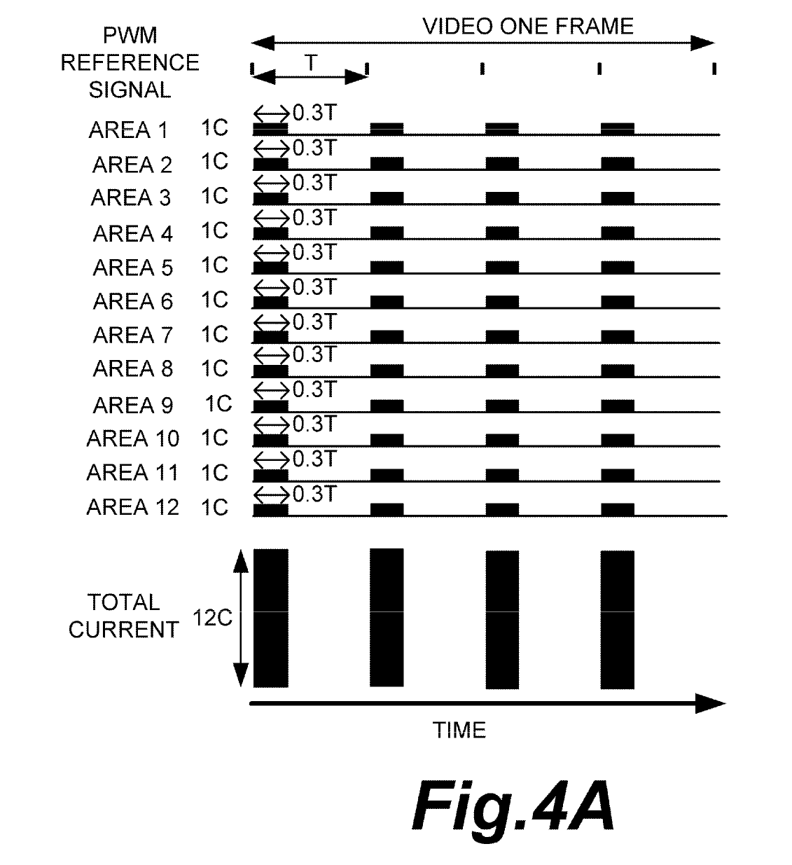

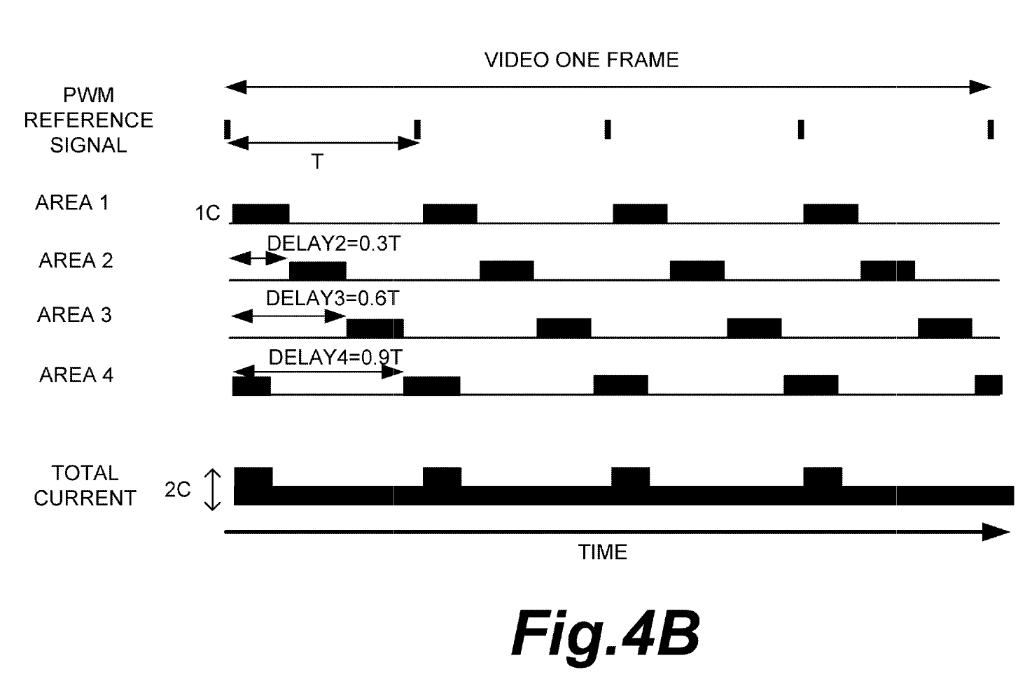

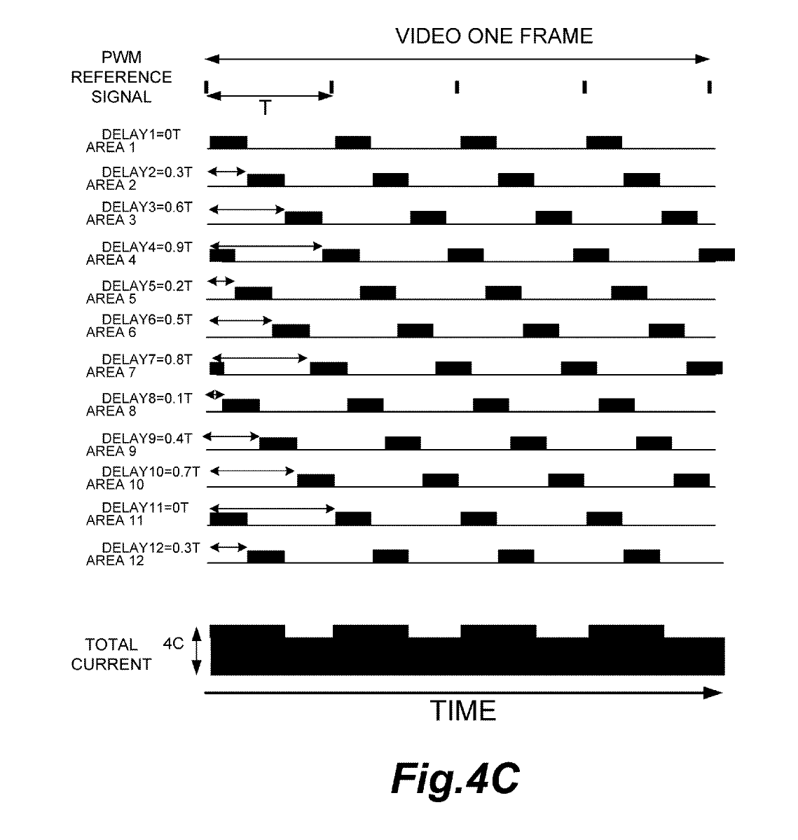

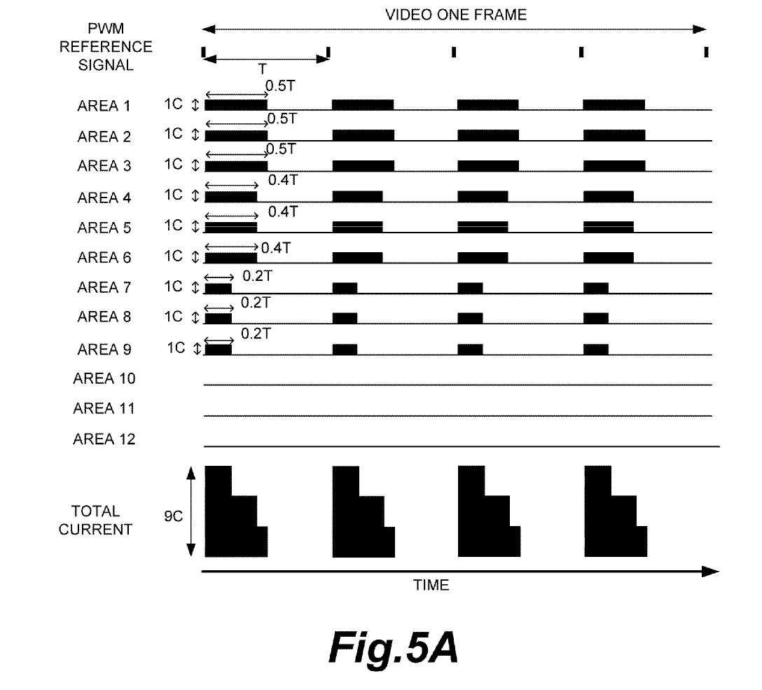

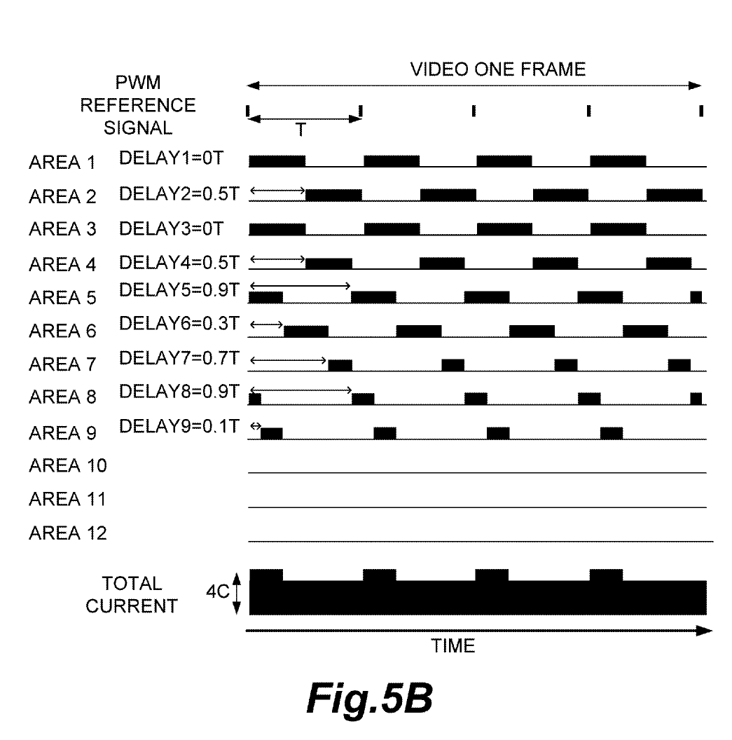

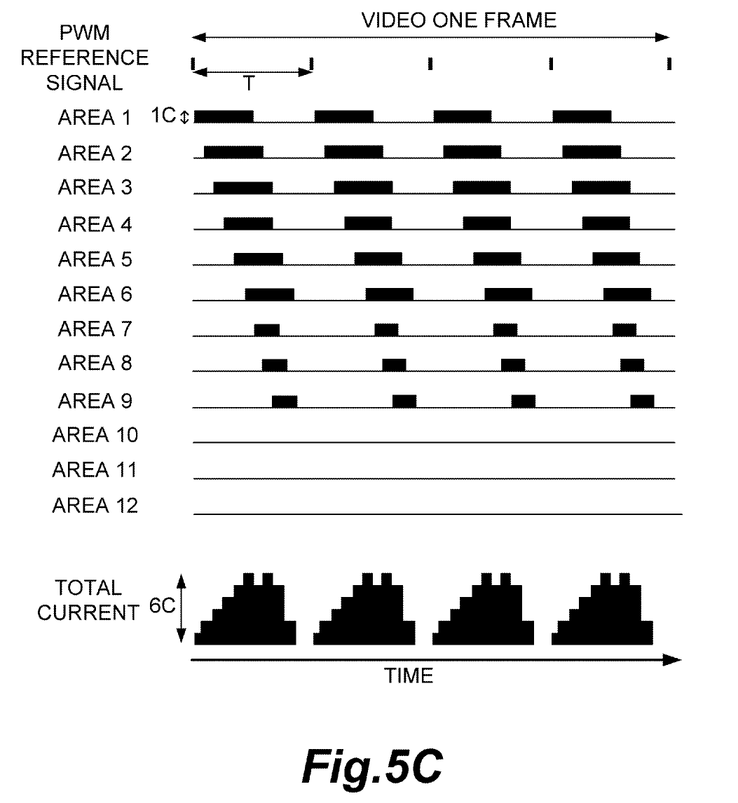

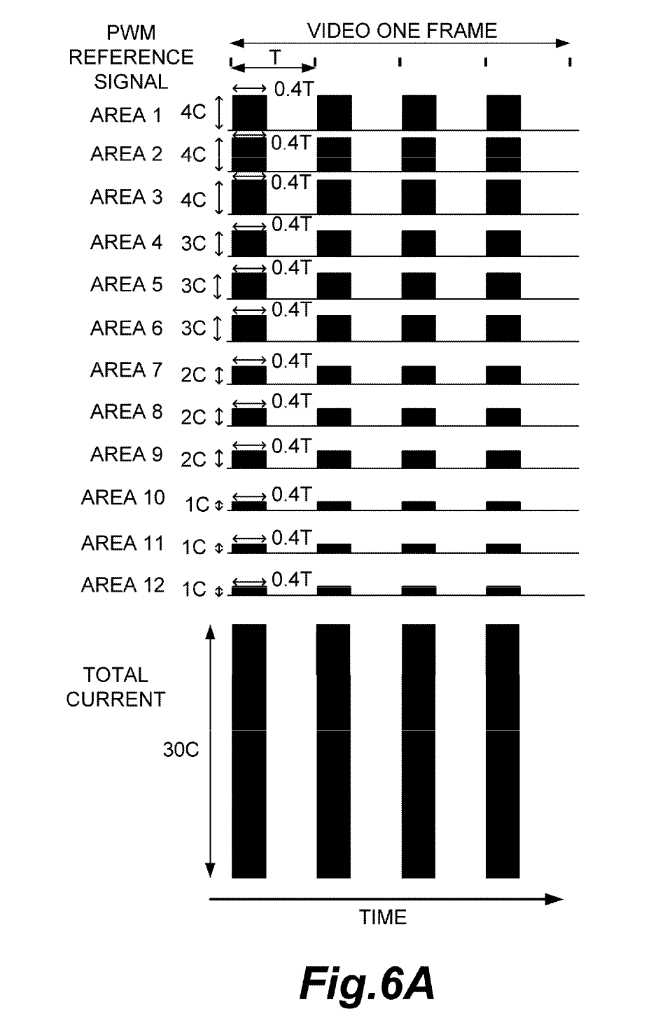

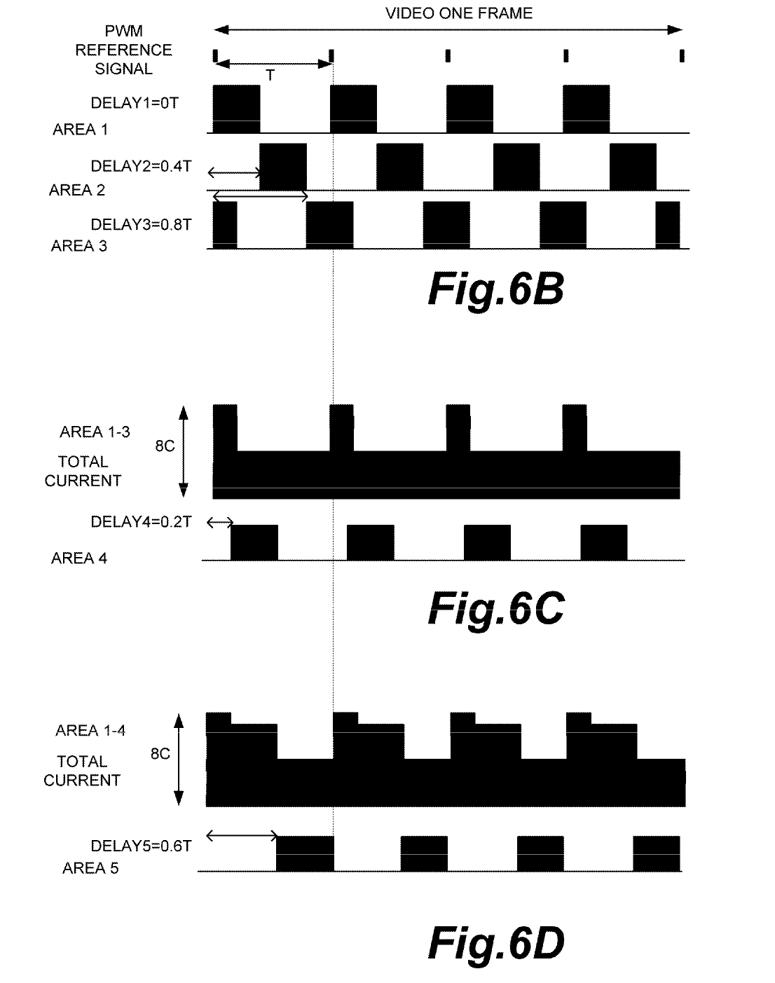

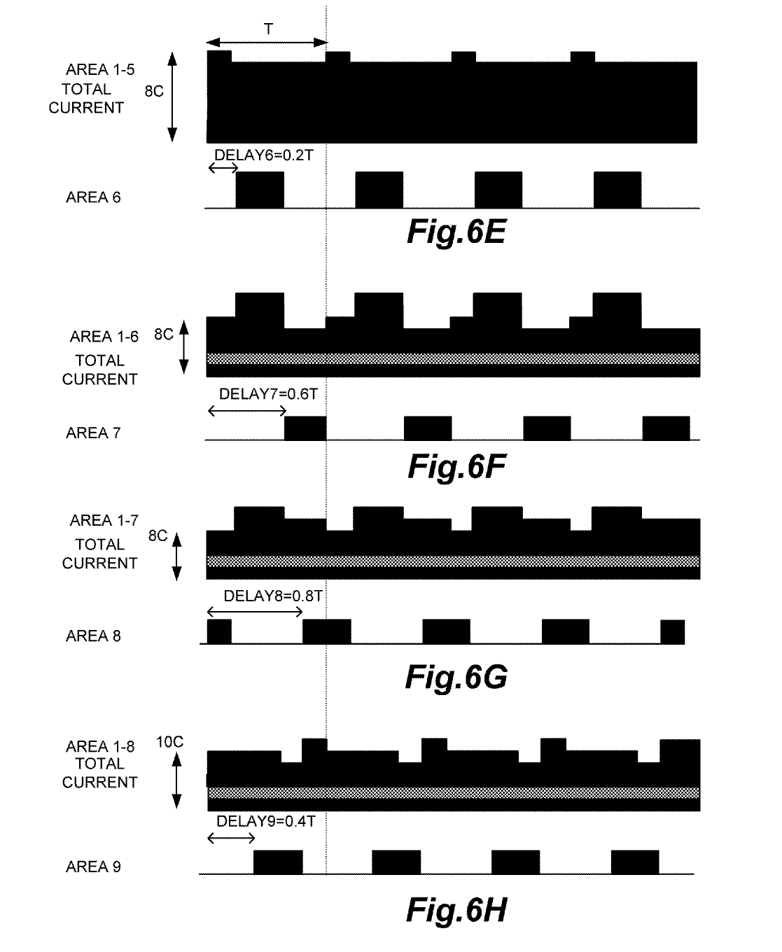

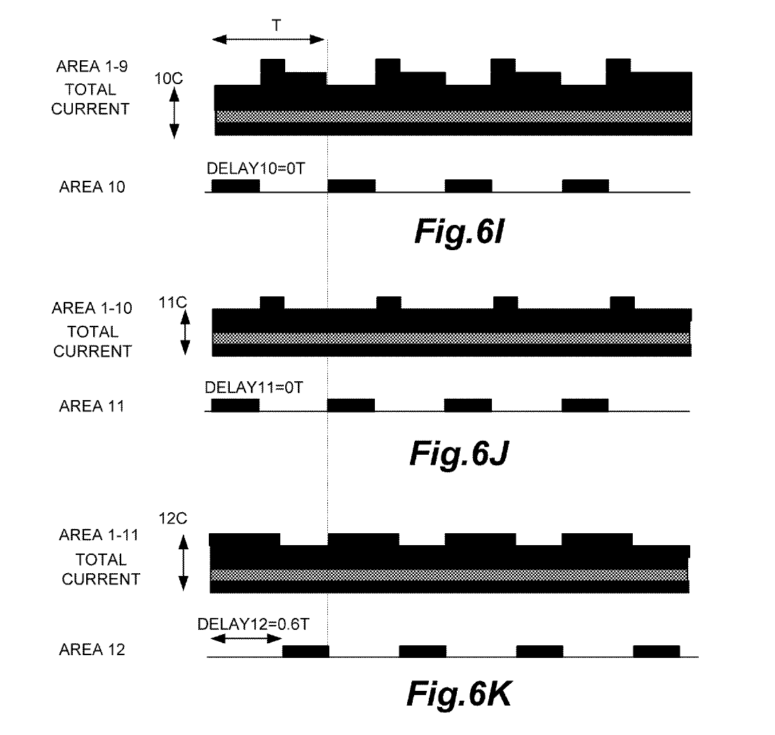

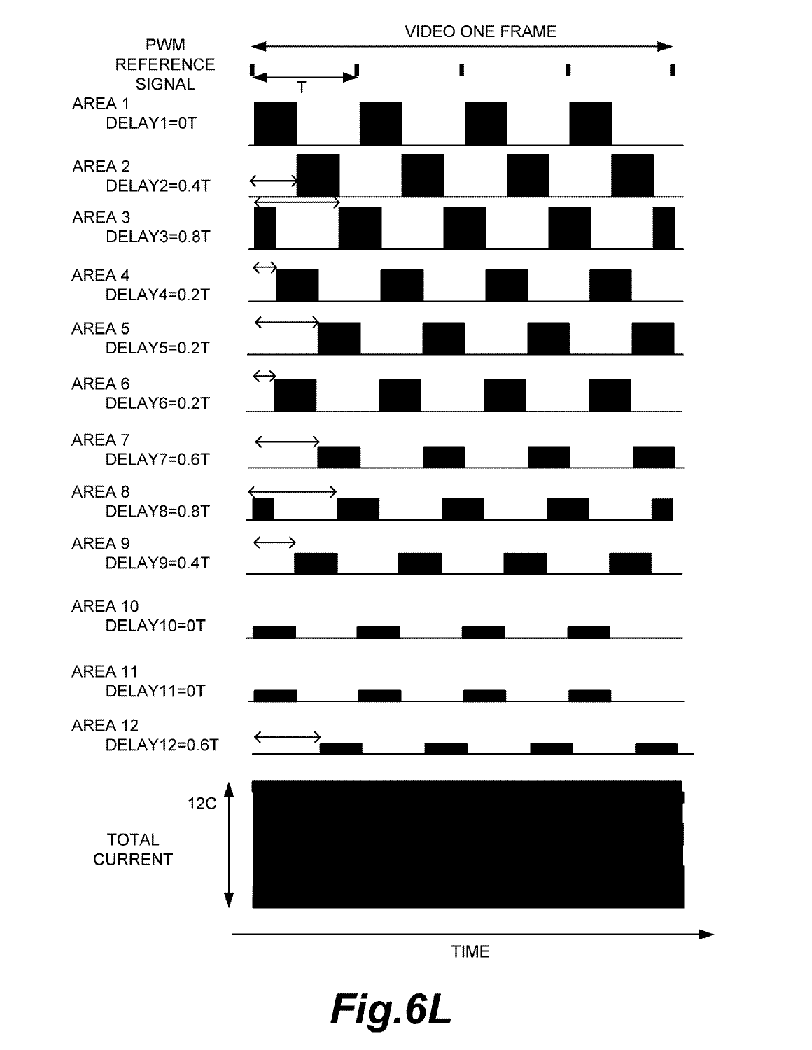

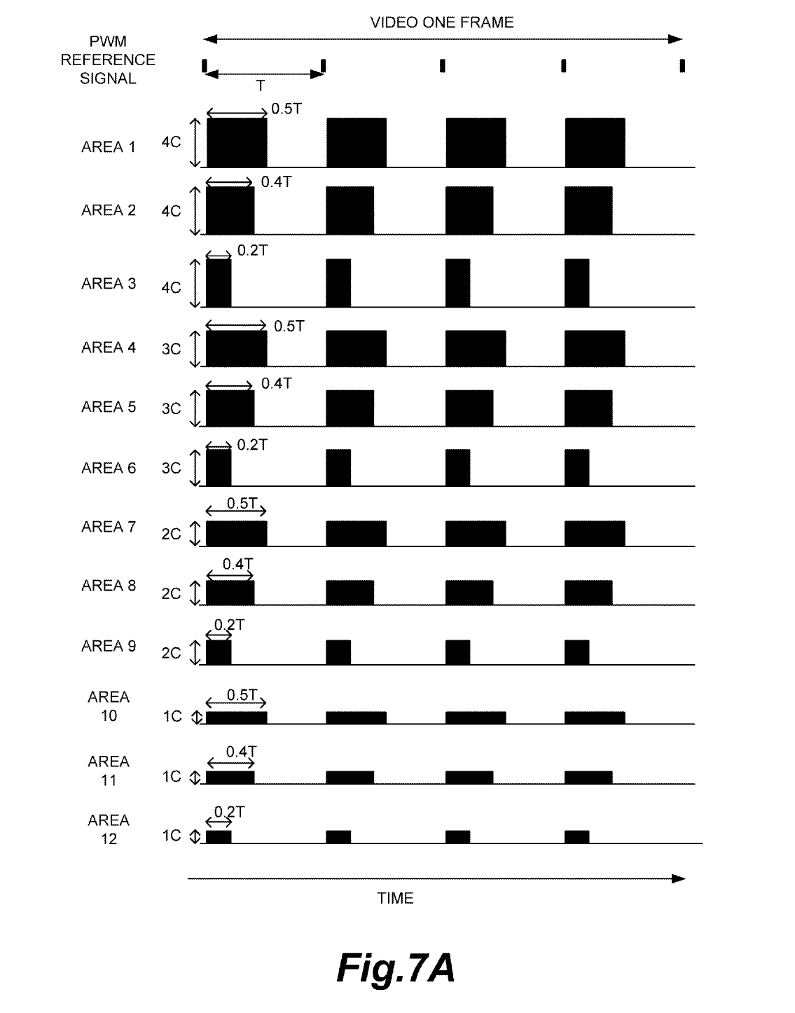

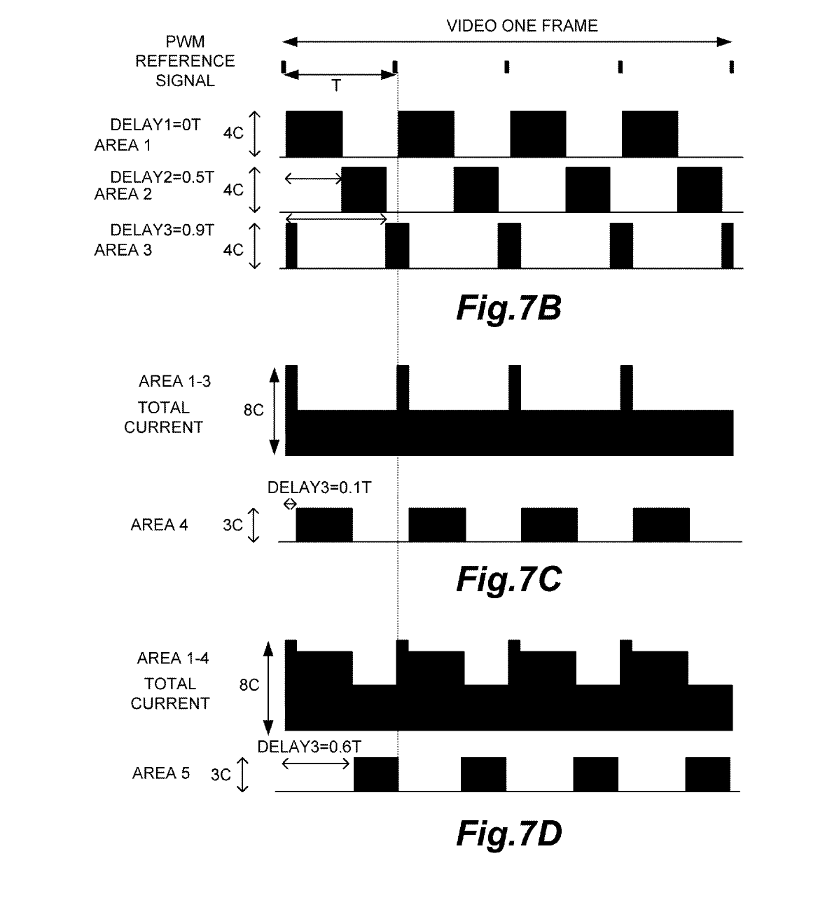

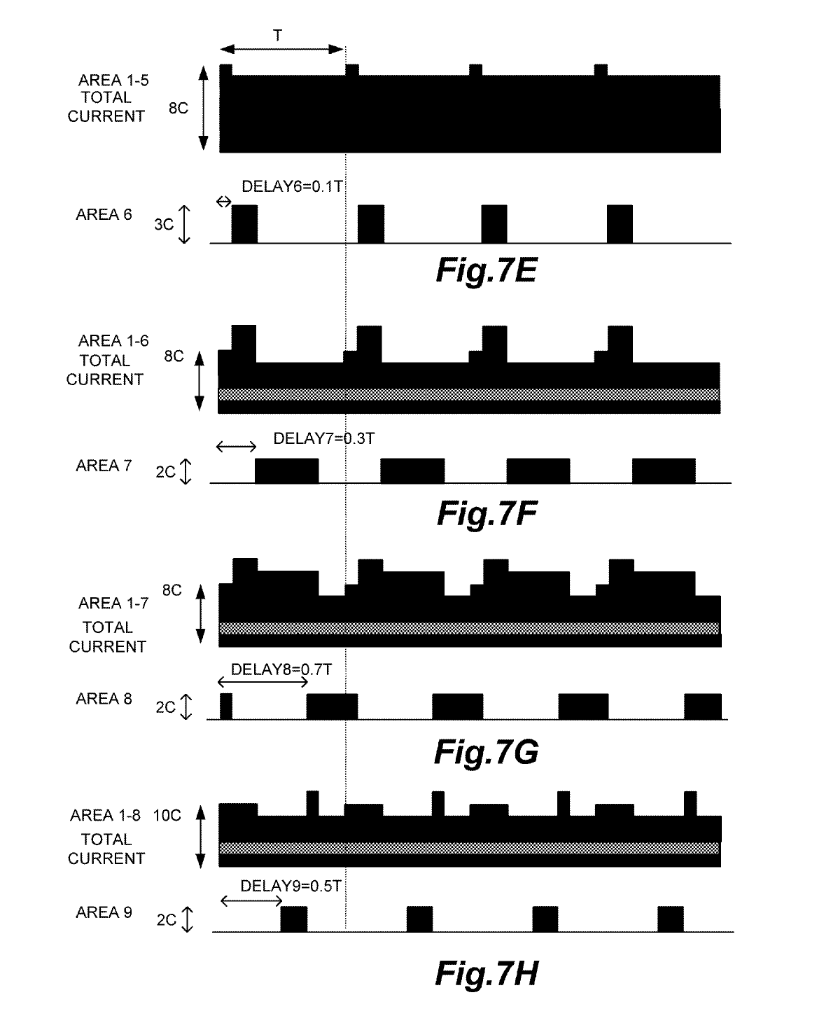

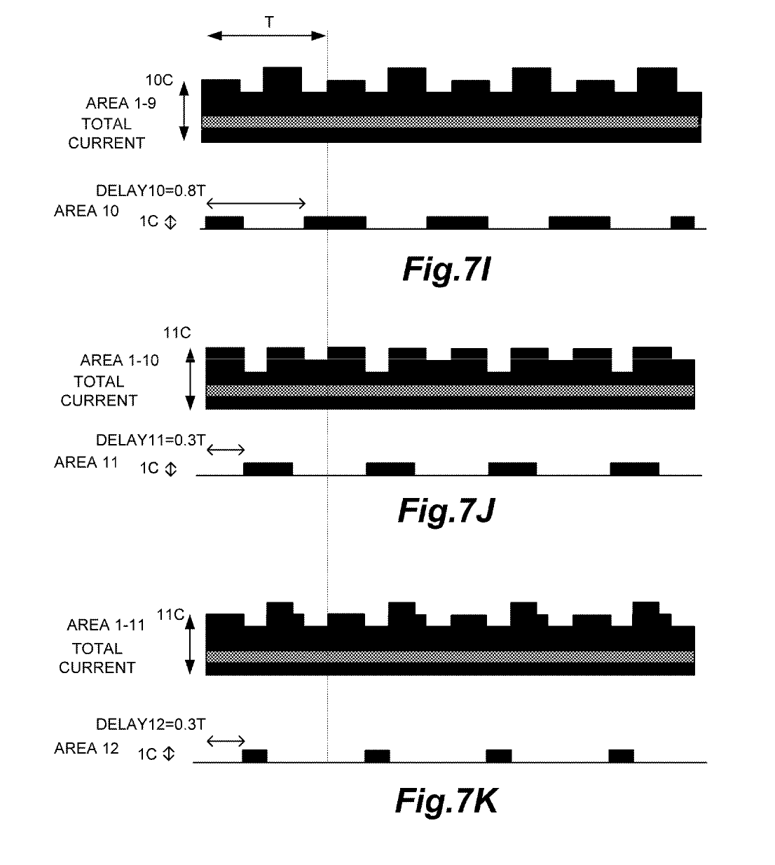

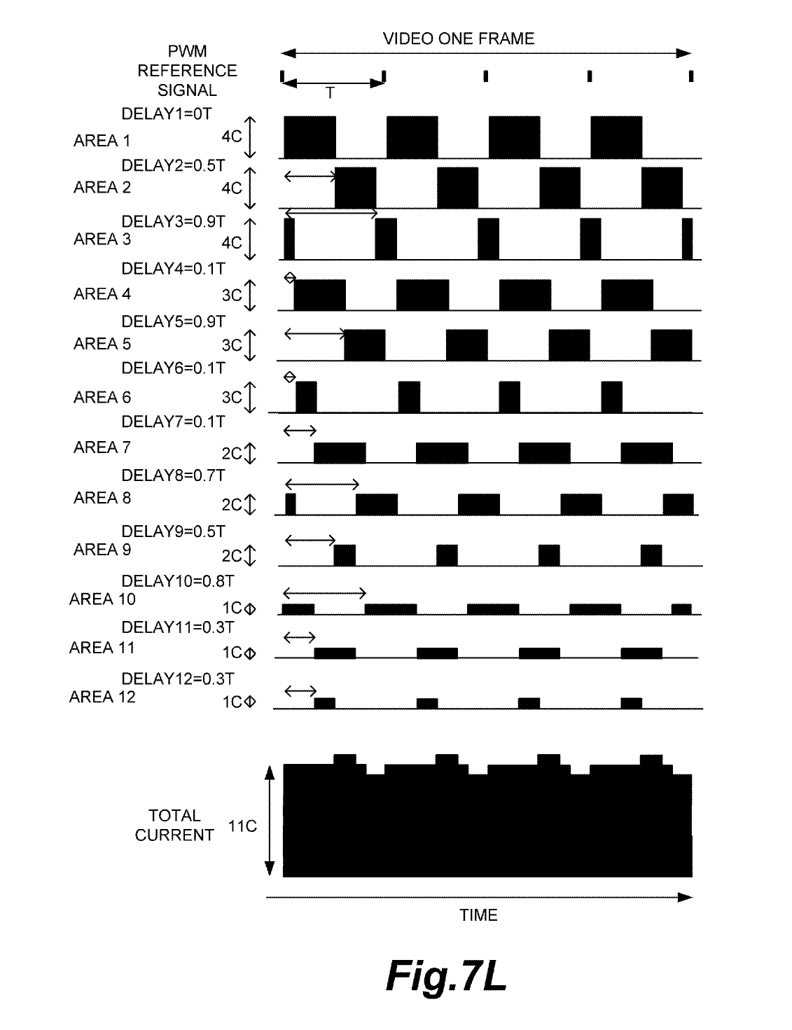

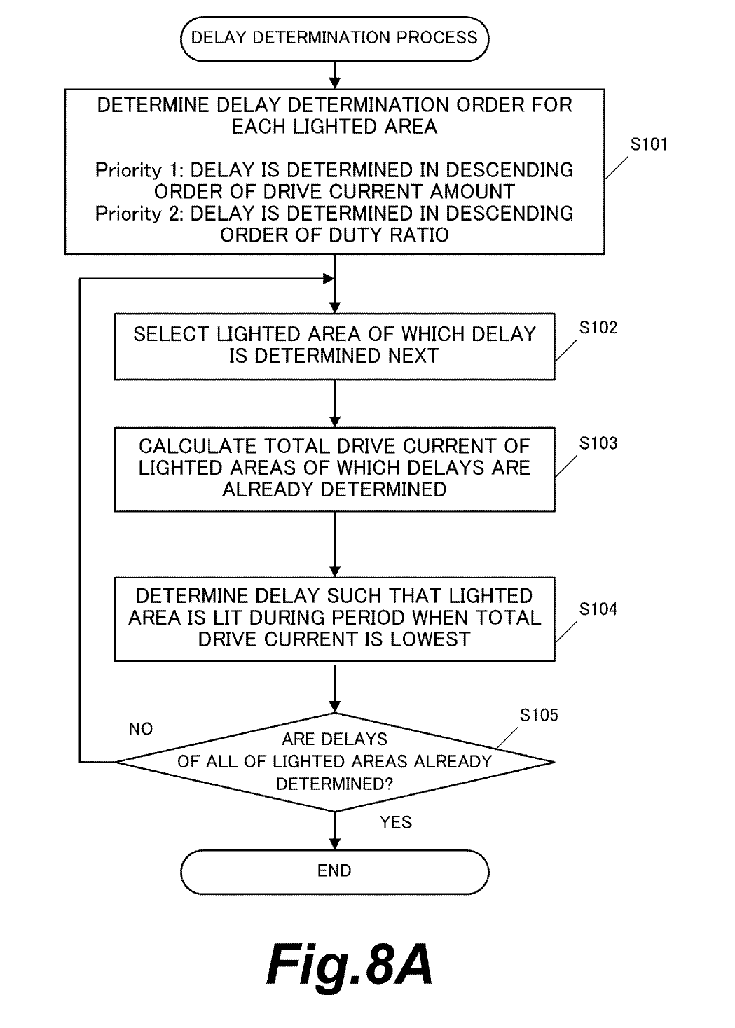

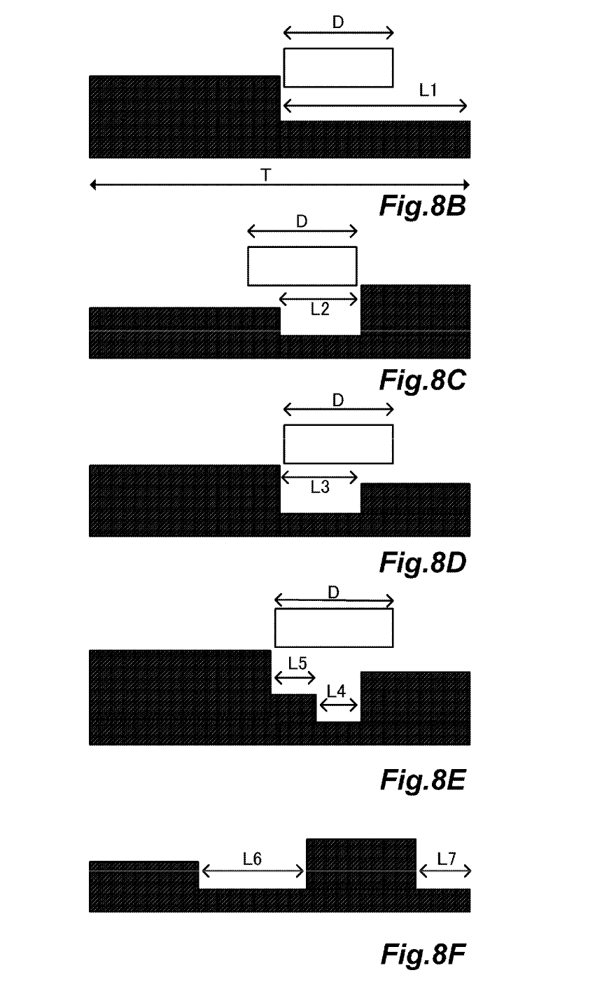

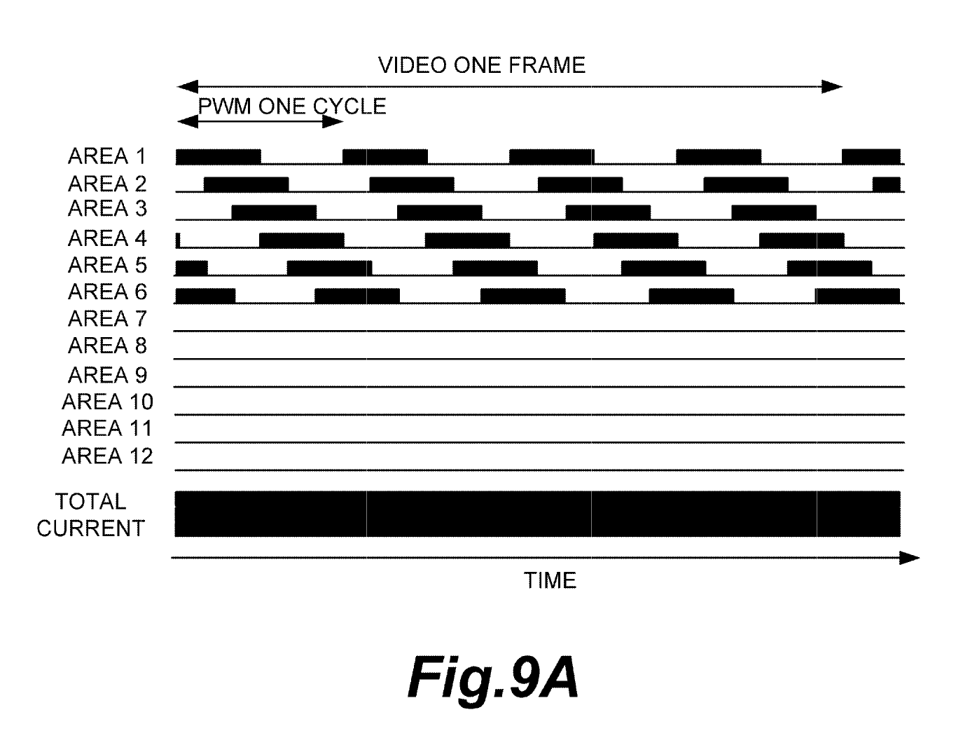

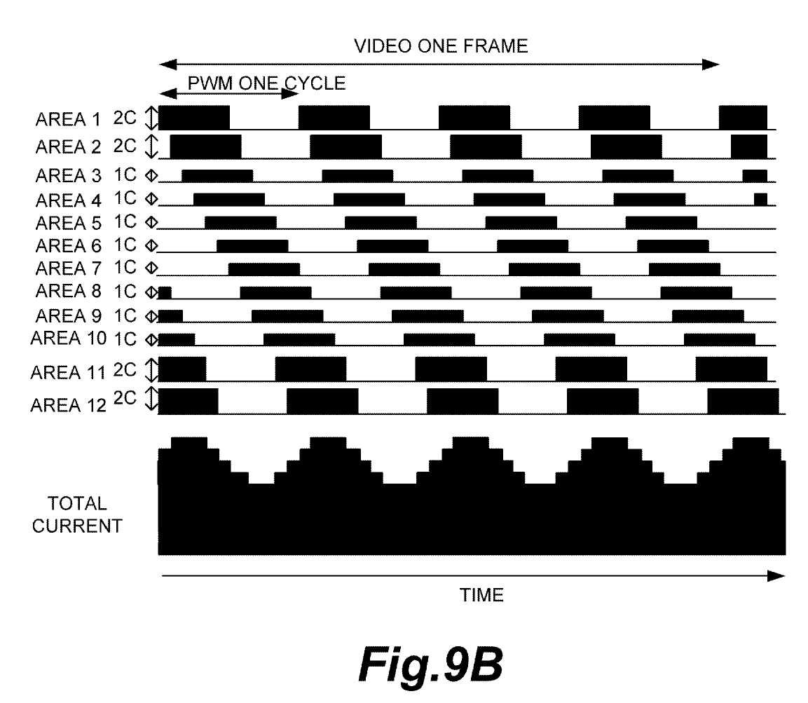

A first embodiment of the present invention will be described. FIG. 1 is a block diagram showing the outline of an image display device according to the present embodiment. An image display device 100 receives an input of an image signal from an image input unit 101, and analyzes the input image signal in an image analysis unit 102. A liquid crystal display (LCD) control unit 103 controls an LCD panel 104 in accordance with the analysis result of the image analysis unit 102 to align the liquid crystal of each pixel of the LCD and allow image display. In addition, a backlight control unit 105 sets a duty ratio (a ratio between a lighting period and a light-out period) of PWM control (pulse width modulation control) required by an LED driver 106 or the like in accordance with the analysis result of the image analysis unit 102. The backlight control unit 105 is capable of controlling a lighting phase for each LED driver in addition to the duty ratio of the PWM control. In the present embodiment, it is assumed that the same pulse amplitude (a drive current of an LED) is used in the PWM control. The image analysis unit 102, the LCD control unit 103, and the backlight control unit 105 may be implemented using a dedicated hardware circuit and may also be implemented using a computer in which a general purpose processor executes a program.

The LED driver 106 has a plurality of channels, each channel is connected to the LED as a light source constituting a backlight 107, and the LED is lit based on a condition set in each channel. The backlight 107 illuminates the LCD panel 104, and an image is thereby displayed in an image display unit 108. Only one LED may be connected to one channel, and a plurality of the LEDs may also be connected to one channel. The numbers of LEDs of the individual channels may be equal to each other, and may also be different from each other. Hereinbelow, the LED controlled by the same channel of the LED driver 106 is referred to as a lighted area of the LED.

In the present embodiment, the description will be given by taking the case where the area of the backlight 107 is divided into twelve lighted areas arranged in a matrix as shown in FIG. 2A and the duty ratio of the PWM and a lighting timing can be controlled for each lighted area as an example. However, the number of lighted areas and the arrangement of the lighted areas may be determined arbitrarily. For example, as shown in FIG. 2B, the area of the backlight 107 may be longitudinally divided into twelve lighted areas and the duty ratio of the PWM and the lighting timing may be controllable for each lighted area. The twelve lighted areas shown in FIGS. 2A and 2B correspond to twelve lighted areas obtained by dividing the screen of the image display unit 108. It is to be noted that this is merely illustrative, and the number of divisions is not limited to twelve and the number thereof can be more than or less than twelve. In addition, the number of light sources present in one lighted area can be one or a plurality of the light sources can be present in one lighted area.

In order to determine the cycle of the PWM, a PWM reference signal is generated at each cycle of the PWM (e.g., 1/200 second) by the backlight control unit 105. Herein, a time from the generation of the PWM reference signal to start of the lighting of the backlight is defined as a delay time. With the delay time, the lighting phase of the LED during the period of one cycle of the PWM control is determined. Consequently, in the present embodiment, adjustment of the delay time of each LED means adjustment of the lighting phase of each LED. It is possible to set the delay time for each lighted area. In the present embodiment, in order to suppress a fluctuation of a total current, it is possible to set the delay time that differs from one lighted area to another. The fluctuation of the total current denotes a fluctuation of the total of the current amount of the LED in each lighted area during the period of one cycle of the PWM control. Noted that the definition of the delay time is not limited to the above definition and, e.g., a time from the generation of the PWM reference signal to light-out may be defined as the delay time and a time from the generation of the PWM reference signal to the midpoint of a lighting time may also be defined as the delay time.

In the present embodiment, the backlight control unit 105 determines a delay (can also be referred to as the lighting timing or the lighting phase) of the lighted area in the following manner.

1. The delay of the lighted area is determined in descending order of the duty ratio (descending order of the length of the lighting period).

2. The delay of the next lighted area is determined such that the next lighted area is lit during a period when the total value of the drive currents of the lighted areas of which the delays are already determined is lowest.

### First Operation Example

Herein, in order to explain a determination method of the delay time in the present invention, the determination method of the delay in the case where all of the lighted areas have the same drive current amount (also simply referred to as a current amount) and the same duty ratio will be described first. As shown in FIG. 3A, it is assumed that the duty ratio is 50% (0.5 T) and the drive current amount is 1 C as its reference in all of the lighted areas. In this case, when the same phase is set in all of the lighted area and the delay is set to 0 T, as shown in the lower part of FIG. 3A, the fluctuation of the current amount occurs such that the total current amount of 12 C and the total current amount of 0 C are alternately repeated.

A description will be given of an operation example in which the backlight control unit 105 determines the delay of each lighted area according to the above method in the case where the duty ratio and the drive current amount are set in this manner with reference to FIG. 3B.

In this example, the same drive current amount and the same lighting duty ratio are used in all of the lighted areas. Consequently, the determination process of the delay determination order of 1. described above may determine an arbitrary order. Herein, it is assumed that the delay of the lighted area is determined from the lighted area 1 having the smallest lighted area number in ascending order of the lighted area number. In addition, in the present example, in the delay determination process of 2. described above, the delay (the lighting phase) is determined such that the lighting is started at the earliest timing (small phase) during the period when the total value of the drive currents of the lighted areas of which delays are already determined is lowest.

At the time of the delay determination of the lighted area 1, there is no lighted area of which the delay is already determined and the total current amount is 0 at all phases, and hence the delay of the lighted area 1 is set to 0 T.

When the delay of the lighted area 2 is determined, the total current amount is 1 C from the phase 0 T to 0.5 T and is 0 from 0.5 T, and hence the delay of the lighted area 2 is determined to be 0.5 T.

When the delay of the lighted area 3 is determined, the total current amount of the lighted areas 1 to 2 of which the delays are already determined is 1 C at all of the phases. Consequently, the delay of the lighted area 3 is determined to be 0 T.

When the delay of the lighted area 4 is determined, the total current amount of the lighted areas 1 to 3 of which the delays are already determined is 2 C from 0 T to 0.5 T, and is 1 C from 0.5 T to 1 T. Consequently, the delay of the lighted area 4 is determined to be 0.5 T.

When the above operation is repeated, the delays of the lighted areas 5 to 12 are determined to be 0 T, 0.5 T, 0 T, 0.5 T, 0 T, 0.5 T, 0 T, and 0.5 T. The finally determined lighting patterns and total current amounts of the individual lighted areas are shown in FIG. 3B. By determining the delays in this manner, it is possible to reduce the maximum value of the total current amount 12C (FIG. 3A) to 6C that is a half of the value in FIG. 3A. Further, it becomes possible to prevent a temporal fluctuation of the total current value.

### Second Operation Example

Next, as an example in the case where the same duty ratio and the same drive current amount are set in all of the lighted areas, the case where the lighting duty ratio of each lighted area is 30% (0.3 T) and the drive current amount thereof is 10 will be described with reference to FIGS. 4A to 4C. FIG. 4A shows the case where the delays of all of the lighted areas are set to 0 T, and the total current amount significantly fluctuates in a range between 12 C and 0 C.

In this case, the delay determination process by the backlight control unit 105 is as follows. First, similarly to the above first operation example, the delay of the lighted area 1 is determined to be 0 T and, thereafter, by shifting the delay by 0.3 T each time, the delay of the lighted area 2 is determined to be 0.3 T, the delay of the lighted area 3 is determined to be 0.6 T, and the delay of the lighted area 4 is determined to be 0.9 T. Note that the delay of the lighted area 4 is determined to be 0.9 T and the duty ratio thereof is 0.3 T, and hence the lighted area 4 is lit during periods from 0 T to 0.2 T and from 0.9 T to 1.0 T.

The lighting periods of the lighted areas 1 to 4 based on the above determination are shown in FIG. 4B. The total drive current at each phase is 2 C from 0 T to 0.2 T, and is 10 from 0.2 T to 1 T. Consequently, the delay of the lighted area 5 is determined to be 0.2 T. Similarly, the delay of the lighted area 6 is determined to be 0.5 T, the delay of the lighted area 7 is determined to be 0.8 T, the delay of the lighted area 8 is determined to be 0.1 T, the delay of the lighted area 9 is determined to be 0.4 T, the delay of the lighted area 10 is determined to be 0.7 T, the delay of the lighted area 11 is determined to be 0 T, and the delay of the lighted area 12 is determined to be 0.3 T. Thus, the delays of all of the lighted areas are determined.

The lighting patterns and the total drive current amounts of all of the lighted areas 1 to 12 after the delay determination are shown in FIG. 4C. As can be seen from the drawing, the maximum value of the total drive current amount is 4 C and the minimum value thereof is 3 C, and the fluctuation therebetween is 10. The total current amount fluctuates in a range between 12 C and 0 C in the case of the method of FIG. 4A in which the delay is equally set in all of the lighted areas, but it becomes possible to suppress the fluctuation amount by the present method.

### Third Operation Example

Next, a description will be given with reference to FIGS. 5A to 5C by taking the case where all of the lighted areas have the same drive current amount and the duty ratio differs from one lighted area to another as an example. Herein, it is assumed that the duty ratio of each of the lighted areas 1 to 3 is 50% (0.5 T), the duty ratio of each of the lighted areas 4 to 6 is 40% (0.4 T), the duty ratio of each of the lighted areas 7 to 9 is 20% (0.2 T), and the duty ratio of each of the lighted areas 10 to 12 is 0% (0 T). FIG. 5A shows the case where the delays of all of the lighted areas are set to 0 T.

In this case, the delay determination process by the backlight control unit 105 is as follows. The delay of the lighted area is determined in descending order of the duty ratio, and the determination order in the case where the lighted areas have the same duty ratio is arbitrarily determined. Accordingly, in the present example, the delay is determined in the order of the lighted areas 1 to 12. Note that, for clear description, the duty ratio is set such that the delay determination order matches the order of the lighted area numbers in this example, but the present invention is not actually limited thereto.

Next, the delay determination of each lighted area will be described. When the delay is determined based on the total current amount of the lighted areas of which the delays are already determined, as shown in FIG. 5B, the delay of the lighted area 1 is determined to be 0 T, the delay of the lighted area 2 is determined to be 0.5 T, and the delay of the lighted area 3 is determined to be 0 T.

When the delays of the lighted areas 1 to 3 are determined, the delays of the lighted areas 4 to 6 having the second highest duty ratio are then determined. With the delay determination that has been performed, the total of the drive current amounts is 2 C from 0 T to 5 T, and is 1 C from 0.5 T to 1.0 T.

Consequently, the delay of the lighted area 4 is determined to be 0.5 T, and the total of the drive current amounts is 2 C from 0 T to 0.9 T, and is 1 C from 0.9 T to 1.0 T.

The delay of the lighted area 5 is determined to be 0.9 T, and the total of the drive current amounts is 3 C from 0 T to 0.3 T, and is 2 C from 0.3 T to 1.0 T.

The delay of the lighted area 6 is determined to be 0.3 T, and the total of the drive current amounts is 3 C from 0 T to 0.7 T, and is 2 C from 0.7 T to 1.0 T.

When the delays of the lighted areas 1 to 6 are determined, the delays of the lighted areas 7 to 9 having the third highest duty ratio are then determined.

Similarly, the delay of the lighted area 7 is determined to be 0.7 T, and the total of the drive current amounts is 3 C from 0 T to 0.9 T, and is 2 C from 0.9 T to 1.0 T.

The delay of the lighted area 8 is determined to be 0.9 T, and the total of the drive current amounts is 4 C from 0 T to 0.1 T, and is 3 C from 0.1 T to 1.0 T.

The delay of the lighted area 9 is determined to be 0.1 T, and the total of the drive current amounts is 4 C from 0 T to 0.3 T, and is 3 C from 0.9 T to 1.0 T.

The duty ratio of each of the lighted areas 10 to 12 is 0 T (no lighting), and hence the delay is not particularly set. The lighting patterns and the total drive current amounts when the delays are set in the manner described above are shown in FIG. 5B. It can be seen that the total current falls within a range between 3 C and 4 C, and the fluctuation of the total current amount is suppressed.

For comparison, the lighting patterns and the total currents in the case where the delay of each lighted area is shifted by 1/12 T and fixed without using the duty ratio as in Japanese Patent Application Laid-open No. 2009-188135 are shown in FIG. 5C. Through comparison with this case as well, it can be seen that the suppression of fluctuation of the total current amount is achieved by the method of the present embodiment.

By setting the delay time using the method described above, it is possible to prevent an increase in the fluctuation range of the total current amount as shown in FIG. 5A, and implement a lighting state like the state in FIG. 5B in which the fluctuation of the total current amount is suppressed. In FIG. 5B, although the fluctuation of the current amount is not suppressed completely, it becomes possible to further reduce the fluctuation ratio of the total current by increasing the number of lighted area divisions.

In addition, in the present embodiment, the method for determining the delay time of each lighted area such that, on the assumption that the backlight is driven by one power supply, the fluctuation of the total current of the power supply is suppressed has been described. In the case where the backlight is driven by a plurality of the power supplies, the delay time of each lighted area is set such that the fluctuation of the total current of each power supply is suppressed. For example, there are cases where an upper half of the screen (the lighted areas 1 to 6 in FIGS. 2A and 2B) and a lower half of the screen (the lighted areas 7 to 12 in FIGS. 2A and 2B) are driven by different power supplies. In these cases, it is preferable to determine the delay values in the lighted areas 1 to 6 by using the method of the present embodiment and, at the same time determine the delay values in the lighted areas 7 to 12.

As described above, by using the control method for the backlight described in the present embodiment, when local dimming control is performed as well, it is possible to suppress a significant fluctuation of supplied power (the total current amount flowing to the LED of the backlight) in the power supply that performs power supply to the backlight. Consequently, it becomes possible to achieve design of the power supply in which power efficiency is excellent and cost is reduced, and realize low power consumption and low cost.

### Second Embodiment

The present embodiment is the image display device having the backlight capable of controlling the drive current of the LED for each lighted area. The configuration and the process of the present embodiment are basically the same as those of the first embodiment. The present embodiment is different from the first embodiment mainly in that the drive current differs from one LED (lighted area) to another.

An example in which the drive current is changed on a per lighted area basis includes the case where the drive current of the LCD driver 106 is set to values that differ from one lighted area to another in advance. For example, the brightness tends to be lower in the peripheral portion of the screen than in the central portion thereof in the LED backlight, and hence the backlight in which the drive current in the peripheral portion of the screen is set to a high value and brightness unevenness is thereby reduced is conceivable.

Alternatively, the backlight control unit 105 may determine not only the duty ratio (pulse width) but also the drive current amount (pulse amplitude) of the backlight for each lighted area in accordance with image data. That is, lighting and light-out of the LED is controlled using both of pulse amplitude modulation (PAM) and the pulse width modulation (PWM) (also referred to as PHM: pulse harmonic modulation). With this, it is possible to increase the number of control gradations in the case where the brightness is changed on a per lighted area basis by the local dimming control.

In the present embodiment, the delay determination process by the backlight control unit 105 is different from that of the first embodiment in that the delay of the lighted area is determined in descending order of the drive current amount. The other points of the present embodiment are the same as those of the first embodiment.

### Fourth Operation Example

The determination method of the delay will be described with reference to FIGS. 6A to 6L by taking the case where the drive current amount of the LED differs from one lighted area to another and all of the lighted areas have the same duty ratio as an example. Herein, it is assumed that the drive current amount of each of the lighted areas 1 to 3 is 4 C, the drive current amount of each of the lighted areas 4 to 6 is 3 C, the drive current amount of each of the lighted areas 7 to 9 is 2 C, and the drive current amount of each of the lighted areas 10 to 12 is 1 C. In addition, it is assumed that all of the lighted areas have the same duty ratio of 40% (0.4 T). The lighting patterns in the case where the delays of all of the lighted areas are set to 0 T are shown in FIG. 6A and, in this case, the total drive current fluctuates in a range between 30 C and 0 C.

The delay determination process by the backlight control unit 105 in this case is as follows. The determination of the delay is performed in descending order of the drive current amount. The determination order in the case where the drive current amounts are equal to each other is arbitrarily determined. Consequently, in the present example, the delay determination order is determined such that the delay is determined in the order of the lighted areas 1 to 12. Noted that, for clear description, the drive current amount is set such that the delay determination order matches the order of the lighted area numbers in this example, but the present invention is not actually limited thereto.

The determination method of the delay of each lighted area is basically the same as that of the first embodiment, and the delay is determined by the method in which “the delay is determined such that the phase having the lowest total current of the lighted areas of which the delays are already determined corresponds to the lighting period”. First, the delay of the lighted area 1 is determined to be 0 T. Next, the delay of the lighted area 2 is determined to be 0.4 T, and the delay of the lighted area 3 is determined to be 0.8 T similarly. The lighting patterns after the delay of the lighted area 3 is determined are shown in FIG. 6B.

As shown in the upper part of FIG. 6C, the total drive current at the time point when the delay of the lighted area 3 is determined is 8 C from 0 T to 0.2 T, and is 4 C from 0.2 T to 1 T. Consequently, as shown in the lower part of FIG. 6C, the delay of the lighted area 4 is determined to be 0.2 T.

As shown in the upper part of FIG. 6D, the total drive current at the time point when the delay of the lighted area 4 is determined is 8 C from 0 T to 0.2 T, is 7 C from 0.2 T to 0.6 T, and is 4 C from 0.6 T to 1 T. Consequently, as shown in the lower part of FIG. 6D, the delay of the lighted area 5 is determined to be 0.6 T.

As shown in the upper part of FIG. 6E, the total drive current at the time point when the delay of the lighted area 5 is determined is 8 C from 0 T to 0.2 T, and is 7 C from 0.2 T to 1 T. Consequently, as shown in the lower part of FIG. 6E, the delay of the lighted area 6 is determined to be 0.2 T.

As shown in the upper part of FIG. 6F, the total drive current at the time point when the delay of the lighted area 6 is determined is 8 C from 0 T to 0.2 T, is 10 C from 0.2 T to 0.6 T, and is 7 C from 0.6 T to 1 T. Consequently, as shown in the lower part of FIG. 6F, the delay of the lighted area 7 is determined to be 0.6 T. Note that the graph of the total current amount is shown in FIG. 6F with its height being omitted. Other graphs indicative of the total current amount that are hatched are also shown with heights being omitted similarly.

As shown in the upper part of FIG. 6G, the total drive current at the time point when the delay of the lighted area 7 is determined is 8 C from 0 T to 0.2 T, is 10 C from 0.2 T to 0.6 T, and is 9 C from 0.6 T to 1 T. Herein, 0 T to 0.2 T as the period when the total drive current amount is smallest is shorter than the lighting period of the lighted area 7 of 0.4 T. Consequently, it is necessary to light the lighted area 7 during a period before or after the period when the total drive current amount is smallest. At this point, in order to reduce the fluctuation of the total drive current amount, the delay is determined such that the lighted area 7 is lit also during a period which is one of periods before and after the period when the total drive current amount is smallest, and in which the total drive current amount is smaller. In this example, the period from 0.6 T to 1 T as the period before 0 T to 0.2 T is smaller in total drive current amount smaller than the period from 0.2 T to 0.6 T as the period after 0 T to 0.2 T, and hence the delay is controlled such that the lighted area 7 is lit also from 0.6 T to 1 T. In order to light the lighted area throughout the period when the total drive current is lowest (0 T to 0.2 T), as shown in the lower part of FIG. 6G, the delay is determined such that the lighting end timing of the lighted area 7 corresponds to 0.2 T, i.e., the delay (the lighting start timing) is determined to be 0.8 T.

As shown in the upper part of FIG. 6H, the total drive current amount at the time point when the delay of the lighted area 8 is determined is 10 C from 0 T to 0.6 T, is 9 C from 0.6 T to 0.8 T, and is 11 C from 0.8 T to 1 T. Therefore, similarly to the above operation, the delay of the lighted area 9 is determined so as to extend over 0.6 T to 0.8 T when the current amount is smallest and 0 T to 0.6 T when the current amount is second smallest. Herein, as shown in the lower part of FIG. 6H, the delay is determined to be 0.4 T such that the lighting end timing of the lighted area 8 corresponds to 0.8 T.

As shown in the upper part of FIG. 6I, the total drive current at the time point when the delay of the lighted area 9 is determined is 10 C from 0 T to 0.4 T, is 12 C from 0.4 T to 0.6 T, and is 11 C from 0.6 T to 1 T. Consequently, as shown in the lower part of FIG. 6I, the delay of the lighted area 10 is determined to be 0 T.

As shown in the upper part of FIG. 6J, the total drive current at the time point when the delay of the lighted area 10 is determined is 11 C from 0 T to 0.4 T, is 12 C from 0.4 T to 0.6 T, and is 11 C from 0.6 T to 1 T. Consequently, as shown in the lower part of FIG. 6J, the delay of the lighted area 11 is determined to be 0 T.

As shown in the upper part of FIG. 6K, the total drive current amount at the time point when the delay of the lighted area 11 is determined is 12 C from 0 T to 0.6 T, and is 11 C from 0.6 T to 1 T. Consequently, as shown in the lower part of FIG. 6K, the delay of the lighted area 12 is determined to be 0.6 T.

The lighting patterns and the total drive currents obtained by determining all of the delays in the manner described above are shown in FIG. 6L. Herein, the total current amount is 12 C at all of the phases, and the fluctuation is not present. This is only an example, and there are cases where a little fluctuation actually occurs depending on the current amount and the duty ratio of each lighted area. However, in either case, it becomes possible to suppress the increase in fluctuation range, and reduce the fluctuation ratio by increasing the number of lighted area divisions similarly to the case of the first embodiment.

### Third Embodiment

A third embodiment is the image display device having the backlight capable of controlling the drive current and the duty ratio of the LED of each lighted area. The configuration and the process of the present embodiment are basically the same as those of the second embodiment. The present embodiment is different from the second embodiment mainly in that not only the drive current amount but also the duty ratio differs from one LED to another. For example, as described above, the present embodiment is the backlight device in which uniformity is achieved by eliminating the brightness unevenness by changing the drive current value and the control for changing the brightness on a per lighted area basis in accordance with the image by the local dimming control is implemented by changing the duty ratio.

### Fifth Operation Example

Herein, the determination method of the delay will be described with reference to FIGS. 7A to 7L by taking the case where the drive current amount and the duty ratio of the LED differ from one lighted area to another as an example. In the present example, as shown in FIG. 7A, the drive current amount of each of the lighted areas 1 to 3 is 4 C, the drive current amount of each of the lighted areas 4 to 6 is 3 C, the drive current amount of each of the lighted areas 7 to 9 is 2 C, and the drive current amount of each of the lighted areas 10 to 12 is 1 C. It is assumed that the lighting duty ratio of the PWM is 50% (0.5 T) in the lighted areas 1, 4, 7, and 10, 40% (0.4 T) in the lighted areas 2, 5, 8, and 11, and 20% (0.2 T) in the lighted areas 3, 6, 9, and 12. The lighting patterns in the case where the delays of all of the lighted areas are set to 0 T are shown in FIG. 7A. Although the total drive current is not shown in FIG. 7A, it can be seen that a large current fluctuation occurs.

The delay determination process by the backlight control unit 105 in this case is as follows. The determination of delay of the lighted area is performed in descending order of the drive current amount and, in the case where a plurality of the lighted areas having the same drive current are present, the delay of the lighted area is determined in descending order of the duty ratio. The determination order in the case where a plurality of the lighted areas having the same drive current amount and the same duty ratio are present is arbitrarily determined. Consequently, in the present example, the delay determination order is determined such that the delay is determined in the order of the lighted areas 1 to 12. Note that, for clear description, the drive current amount is set such that the delay determination order matches the order of the lighted area numbers in this example, but the present invention is not actually limited thereto.

First, the delay of the lighted area 1 is determined to be 0 T. The delay of the next lighted area 2 is determined to be 0.5 T. Similarly, the delay of the lighted area 3 is determined to be 0.9 T. The lighting patterns after the delay of the lighted area 3 is determined are shown in FIG. 7B.

As shown in the upper part of FIG. 7C, the total drive current amount at the time point when the delay of the lighted area 3 is determined is 8 C from 0 T to 0.1 T, and is 4 C from 0.1 T to 1 T. Consequently, as shown in the lower part of FIG. 7C, the delay of the lighted area 4 is determined to be 0.1 T. As shown in the upper part of FIG. 7D, the total drive current amount at the time point when the delay of the lighted area 4 is determined is 8 C from 0 T to 0.1 T, is 7 C from 0.1 T to 0.6 T, and is 4 C from 0.6 T to 1 T. Consequently, as shown in the lower part of FIG. 7D, the delay of the lighted area 5 is determined to be 0.6 T.

As shown in the upper part of FIG. 7E, the total drive current amount at the time point when the delay of the lighted area 5 is determined is 8 C from 0 T to 0.1 T, and is 7 C from 0.1 T to 1 T. Consequently, as shown in the lower part of FIG. 7E, the delay of the lighted area 6 is determined to be 0.1 T.

As shown in the upper part of FIG. 7F, the total drive current amount at the time point when the delay of the lighted area 6 is determined is 8 C from 0 T to 0.1 T, is 10 C from 0.1 T to 0.3 T, and is 7 C from 0.3 T to 1 T. Consequently, as shown in the lower part of FIG. 7F, the delay of the lighted area 7 is determined to be 0.3 T.

As shown in the upper part of FIG. 7G, the total drive current amount at the time point when the delay of the lighted area 7 is determined is 8 C from 0 T to 0.1 T, is 10 C from 0.1 T to 0.3 T, is 9 C from 0.3 T to 0.8 T, and is 7 C from 0.8 T to 1 T. The lighting period (the duty ratio) of the lighted area 7 is 0.5 T, and is longer than a period obtained by adding 0.8 T to 1 T that has the smallest current amount to 0 T to 0.1 T that follows the above period and has the second smallest current amount. Accordingly, the lighted area 7 is lit also during a period which is one of periods before and after these periods and in which the current amount is smaller, i.e., during the period from 0.3 T to 0.8 T. Herein, as shown in the lower part of FIG. 7G, the delay is determined to be 0.7 T such that the lighting period of the lighted area 8 is ended at 0.2 T.

As shown in the upper part of FIG. 7H, the total drive current amount at the time point when the delay of the lighted area 8 is determined is 10 C from 0 T to 0.3 T, is 9 C from 0.3 T to 0.7 T, is 11 C from 0.7 T to 0.8 T, and is 9 C from 0.8 T to 1 T. Consequently, the delay of the lighted area 9 is determined such that the lighted area 9 is lit during the period of 9 C when the current amount is smallest. Herein, in order to facilitate leveling when the delays of the subsequent lighted areas are determined, the delay of the lighted area 9 is determined to be 0.5 T such that the phases having the current amount of 11 C are successively provided (the lower part of FIG. 7H). Note that the phases having the current amount of 11 C may be successively provided by lighting the lighted area 9 not before the phase having the current amount of 11 C but after the phase having the current amount of 11 C.

As shown in the upper part of FIG. 7I, the total drive current at the time point when the delay of the lighted area 9 is determined is 10 C from 0 T to 0.3 T, is 9 C from 0.3 T to 0.5 T, is 11 C from 0.5 T to 0.8 T, and is 9 C from 0.8 T to 1 T. Herein, as shown in the lower part of FIG. 7I, the delay of the lighted area 10 is determined to be 0.8 T, and 0.8 T to 1.0 T and 0 T to 0.3 T are set as the lighting periods. Note that the delay may be determined to be 0 T, and 0 T to 0.5 T may be set as the lighting period.

As shown in the upper part of FIG. 7J, the total drive current at the time point when the delay of the lighted area 10 is determined is 11 C from 0 T to 0.3 T, is 10 C from 0.3 T to 0.5 T, is 11 C from 0.5 T to 0.8 T, and is 10 C from 0.8 T to 1 T. Consequently, as shown in the lower part of FIG. 7J, the delay of the lighted area 11 is determined to be 0.3 T.

As shown in FIG. 7K, the total drive current amount at the time point when the delay of the lighted area 11 is determined is 11 C from 0 T to 0.3 T, is 10 C from 0.3 T to 0.5 T, is 12 C from 0.5 T to 0.7 T, is 11 C from 0.7 T to 0.8 T, and is 10 C from 0.8 T to 1 T. Consequently, as shown in FIG. 7K, the delay of the lighted area 12 is determined to be 0.3 T. Note that, in this case, the delay may also be determined to be 0.8 T.

The lighting patterns and the total drive current amounts in the state in which the delays of all of the lighted areas from the lighted area 1 to the lighted area 12 are determined in the manner described above are shown in FIG. 7L. As can be seen from the drawing, the significant fluctuation of the current amount is suppressed.

As described above, even in the case where the current amount of each lighted area is not constant and the duty ratio of each lighted area changes by the local dimming control corresponding to the change of the image, as shown in FIG. 7L, it is possible to suppress the significant fluctuation of the total current amount. Therefore, it becomes possible to achieve the design of the power supply in which the power efficiency is excellent and cost is reduced, and realize low power consumption and low cost.

(Delay Determination Process)

The process details in the backlight control unit 105 for realizing the above-described delay determination process (lighting phase determination process) will be described with reference to a flowchart in FIG. 8A. Note that the flowchart in FIG. 8A has the process details capable of suppressing the drive current in the case where at least one of or both of the drive current amount and the duty ratio of the light source differ from one lighted area to another. The delay determination of each of the first to third embodiments can be executed by the process shown in FIG. 8A. However, in the case where the first embodiment in which all of the lighted areas have the same drive current amount and the second embodiment in which all of the lighted areas have the same duty ratio are implemented, a part of the process that considers the case where the drive current amount and the duty ratio differ may be omitted.

The process described in the flowchart in FIG. 8A is performed after the drive current amount and the duty ratio of each lighted area are determined based on input image data. The delay determination process shown in the flowchart is repeatedly executed by the backlight control unit 105.

First, in Step S101, the backlight control unit 105 determines the determination order of the delay (the lighting phase) of each lighted area. Specifically, the delay of the lighted area is determined in descending order of the drive current amount. In the case where a plurality of the lighted areas having the same drive current amount are present, the delay of the lighted area is determined in descending order of the duty ratio. In the case where a plurality of the lighted areas having the same drive current amount and the same duty ratio are present, the delay determination order of the lighted areas may be arbitrarily determined. For example, the delay determination order may be determined in ascending order of the area number or may also be determined at random. Note that the process in Step S101 corresponds to an order determination step of the present invention, and the backlight control unit 105 that executes the process corresponds to an order determination unit of the present invention.

In Step S102 and subsequent Steps, the backlight control unit 105 sequentially determines the delay (the lighting phase) of each lighted area in accordance with the above determination order. In Step S102, the backlight control unit 105 selects the lighted area of which the delay is to be determined next in accordance with the determination order determined in Step S101 from among the lighted areas of which the delays are not determined. Hereinbelow, the lighted area of which the delay is determined next is referred to as a target lighted area.

In Step S103, the backlight control unit 105 calculates the total of the drive current amounts of the light sources of the lighted areas of which the delays are already determined. That is, the drive current amount required at each timing (phase) is grasped. In Step S104, the backlight control unit 105 determines the delay of the target lighted area such that the target lighted area is lit during the period when the total drive current is lowest. By lighting the target lighted area during the period when the total drive current of the areas of which the delays are already determined is lowest, it is possible to suppress the fluctuation of the total drive current of the areas of which the delays are already determined and the target lighted area. In Step S105, the backlight control unit 105 determines whether or not the delays of all of the lighted areas are determined and, in the case where the lighted area of which the delay is not determined remains (S105—NO), the process returns to Step S102. In the case where the delays of all of the lighted areas are determined (S105—YES), the process is ended. Note that the process from Step S102 to Step S105 corresponds to a phase determination process of the present invention, and the backlight control unit 105 that executes the process corresponds to a phase determination unit of the present invention.

In Step S104, the delay is determined such that the target lighted area is lit during the period when the total drive current is lowest, and a more specific delay determination method will be described with reference to FIGS. 8B to 8F. In FIGS. 8B to 8F, a black square indicates the total drive current amount of the lighted areas of which the delays are already determined, and a white square indicates the lighting period of the lighted area as the delay determination target. Each of these drawings shows one cycle of the PWM control.

In FIG. 8B, a period L1 is selected as the lowest current period of the lighted areas of which the delays are determined. Herein, a lighting period D of the target lighted area is not longer than the period L1, and hence it is possible to light the target lighted area during only the period L1. At this point, when the delay is determined such that the lighting of the target lighted area is started at the start timing of the period L1, leveling of the total drive current of the subsequent lighted areas is facilitated.

Each of FIGS. 8C and 8D show an example in the case where the lowest current period is shorter than the lighting period of the target lighted area. In this case, it is necessary to light the target lighted area before or after the lowest current period. Herein, the target lighted area is lit also during a period which is one of periods before and after the lowest current period, and in which the total current amount is smaller.

In FIG. 8C, a period before a lowest current period L2 is smaller in total current amount than a period after the lowest current period L2. Accordingly, the delay is determined such that the target lighted area is lit during the period L2 and the period before the period L2. In order to light the target lighted area throughout the period L2, it is preferable to determine the delay such that the end of the lighting period of the target lighted area matches the end of the period L2.

In FIG. 8D, a period after a lowest current period L3 is smaller in total current amount than a period before the lowest current period L3. Accordingly, the delay is determined such that the target lighted area is lit during the period L3 and the period after the period L3. In order to light the target lighted area throughout the period L3, it is preferable to determine the delay such that the start of the lighting of the target lighted area matches the start of the period L3.

In the case where the periods before and after the lowest current period have the same total drive current, the target lighted area may be lit by using any of the periods before and after the lowest current period.

FIG. 8E shows an example in the case where the lighting period of the target lighted area is longer even when the period before or after the lowest current period is added to the lowest current period. In this example, a lowest current period L4 is shorter than the lighting period D of the target lighted area. A period before the period L4 is smaller in total current amount than a period after the period L4, and hence the target lighted area is also lit during the period. However, a period (L4+L5) obtained by adding the lowest current period to a period L5 before the lowest current period is shorter than the lighting period D of the target lighted area. In this case, the target lighted area is lit by using one of periods before and after the period L4+L5. Similarly to the above operation, the total drive currents of the periods before and after the period L4+L5 are checked and, the period after the period L4+L5 is smaller in total current amount than the period after the period L4+L5, and hence the delay is determined by using the period after the period L4+L5. In the present example, the lighting period of the target lighted area is secured by performing extension of the period twice and, in general, the extension of the period may be repeated until the lighting period of the target lighted area is secured.

FIG. 8F shows an example in the case where two periods when the total current is lowest are present so as to be separated from each other. In FIG. 8F, the total drive current is lowest during a period L6 and a period L7 that are different from each other. In this case, for example, it is considered that the delay is determined such that the target lighted area is lit during one of the periods L6 and L7 that is shorter than the other period. Alternatively, it is considered that the delay is determined such that the target lighted area is lit during one of periods that is larger in the current difference with an adjacent period than the other period. The specific delay determination of the target lighted area after the lowest current period is selected from among a plurality of the lowest current periods may be performed in the manner described above. However, in the case where the lowest current period is longer than the lighting period of the target lighted area, the delay may be appropriately determined such that the lighting period of the target lighted area is adjacent to one of periods before and after the lowest current period that is larger in current amount than the other period.

Although the method for determining the delay of the target lighted area in accordance with predetermined rules has been described thus far, the delay may also be determined by using an exploratory method. Specifically, a plurality of candidates for the delay of the target lighted area are determined based on the total drive current of the lighted areas of which the delays are already determined, fluctuations of the total drive current in the case the individual delay candidates are used are evaluated, and the candidate that minimizes the fluctuation may be determined as the final delay.

The delay candidate can be determined as, for example, the delay with which the lighting of the target lighted area is started or ended at a timing at which the total drive current is changed. Alternatively, the delay candidate may also be a predetermined timing.

The evaluation of the fluctuation of the total drive current may be appropriately performed from viewpoints such as a difference between the maximum value and the minimum value, the maximum value of a change amount at a timing at which the total current amount is switched, and the number of portions obtained by dividing one cycle based on the total drive current. As the difference between the maximum value and the minimum value is smaller, the fluctuation of the current amount can be evaluated to be smaller. As the maximum value of the change amount at the timing at which the total current amount is switched is smaller, there is no significant switching of the drive current amount so that the fluctuation of the current amount can be evaluated to be smaller. As the number of portions obtained by dividing one cycle based on the total drive current is smaller, the number of times of switching of the drive current amount is smaller, and hence the fluctuation of the current amount can be evaluated to be small. In addition, by performing the evaluation, the fluctuation at the present point in time is suppressed, and suppression of the total current amount at the time of the delay determination of the subsequent lighted area is also facilitated.

It is also preferable to determine the delay by combining the method based on the rules and the method based on the exploration. For example, in the case where the number of times of the switching of the total drive current in one cycle is not less than a predetermined number of times, it is conceivable to use the exploratory method.

(Modification)

In each of the embodiments described above, the example in which the present invention is applied to the backlight for the image display device that uses the LED as the light source has been described, but the scope of the present invention is not limited thereto. For example, an organic electro-luminescence (EL) light emitting element may also be used as the light source. In addition, the present invention can be applied to a lighting device other than the backlight of the image display device as long as the lighting device includes a plurality of the light sources, the light emission amount of each light source is subjected to the PWM control, and the duty ratio and the lighting start timing of each light source can be changed at each cycle of the PWM control.

In the above description, the description is given on the assumption that the delay determination process is performed after the delay determination order is determined for all of the lighted areas, but the delay determination process may also be performed while determining the delay determination order. In addition, the method for determining the delay of each lighted area may be a method other than the above-described method as long as the method suppresses the fluctuation of the total drive current.

For example, a value obtained by adding the duty ratio of a preceding lighted area to the delay of the preceding lighted area may be determined as the delay of the next lighted area. In the case where all of the lighted areas have the same drive current amount, the same delay as that of the determination process based on the total drive current amount described by using FIGS. 8A to 8F can be obtained by this method. In the case where the drive current amount differs from one lighted area to another, it is possible to suppress the fluctuation of the drive current better than the conventional art even when the delay is determined by this method.

In addition, the delay determination method may be changed based on whether the drive current amount is the same as or different from that of the preceding lighted area. That is, in the case where the drive current of the lighted area of which the delay is to be determined and the drive current of the lighted area of which the delay has just been determined are equal to each other, the value obtained by adding the duty ratio of the preceding lighted area to the delay thereof is determined as the delay of the target lighted area. In the case where the drive current differs (decreases), the delay is determined by the method described by using FIGS. 8B to 8F. According to this process, it is possible to easily determine the delay while the drive currents are equal to each other, and hence it is possible to reduce an arithmetic calculation amount and suppress the fluctuation of the total drive current.

Further, the delay determination method may also be changed based on another standard instead of whether or not the drive current is equal to that of the preceding lighted area. That is, in the case where the value obtained by adding the duty ratio of the preceding lighted area to the delay thereof does not exceed one cycle, the value is determined as the delay value of the next lighted area. Conversely, in the case where the value obtained by adding the duty ratio of the preceding lighted area to the delay thereof exceeds one cycle, the delay is determined by the method described by using FIGS. 8B to 8F. According to this process as well, it is possible to suppress the total drive current.

In addition, in each of the embodiments described above, the delay value of the lighted area has been determined in descending order of the drive current value or in descending order of the duty ratio in the case of the lighted areas having the same drive current value, but the delay value may not necessarily be determined in descending order of the drive current value or the duty ratio strictly. For example, the lighted areas may be classified into a plurality of levels (groups) based on the magnitude of the drive current value, and the delay of the lighted area may be determined in descending order of the drive current value level. Further, with regard to the duty ratio as well, the lighted areas may be classified into a plurality of levels (groups) based on the magnitude of the duty ratio and, in the case of a plurality of the lighted areas having the same drive current value or belonging to the same drive current value level, the delay may be determined in descending order of the duty ratio level. It is considered that the lighted areas are classified into three levels such as, e.g., high, middle, and low levels. However, the number of levels does not necessarily need to be three, and the number of levels may be two or not less than four. In addition, when it is determined whether or not the total drive currents are equal to each other, without performing strict determination, a difference within a predetermined range may be permitted and it may be determined that the total drive currents are equal to each other.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment (s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-169636, filed on Aug. 22, 2014, which is hereby incorporated by reference herein in its entirety.

What is claimed is:

1. A lighting device comprising:
a plurality of light sources corresponding to a plurality of areas of a screen; and
a control unit configured to control at least one of a duty ratio between a lighting period and an light-out period and a drive current amount of each of the light sources based on input image data, wherein
the control unit controls lighting timings of the light sources in accordance with the drive current amounts of the light sources such that a fluctuation of the total of the drive current amounts of the light sources is suppressed.

2. The lighting device according to claim 1, wherein
the control unit includes:
an order determination unit configured to determine a determination order of the lighting timings of the light sources; and
a phase determination unit configured to sequentially determine the lighting timings of the light sources based on the determination order and determine the lighting timing of the next light source such that a fluctuation of the total of the drive current amounts of the light sources of which the lighting timings are already determined and the drive current amount of the next light source is suppressed.

3. The lighting device according to claim 2, wherein
the order determination unit determines the determination order such that the lighting timing of the light source is determined in descending order of the drive current amount thereof.

4. The lighting device according to claim 3, wherein
the order determination unit determines the determination order such that the lighting timing of the light source is determined in descending order of the duty ratio thereof when a plurality of the light sources have an identical drive current amount.

5. The lighting device according to claim 2, wherein
the order determination unit classifies the drive current amounts of the light sources into a plurality of levels based on a magnitude thereof, and determines the determination order such that the lighting timing of the light source is determined in descending order of the level of the drive current amount thereof.

6. The lighting device according to claim 5, wherein
the order determination unit classifies the duty ratios of the light sources into a plurality of levels based on a magnitude thereof, and determines the determination order such that the lighting timing of the light source is determined in descending order of the level of the duty ratio thereof when a plurality of the light sources belong to an identical level of the duty ratio thereof.

7. The lighting device according to claim 2, wherein
the phase determination unit determines the lighting timing of the next light source such that the next light source is lit at a timing at which the total of the drive current amounts of the light sources of which the lighting timings are already determined is smallest.

8. The lighting device according to claim 7, wherein
the phase determination unit determines the lighting timing of the next light source such that lighting of the next light source is started at an earliest timing among the timings at which the total of the drive current amounts of the light sources of which the lighting timings are already determined is smallest, or the lighting of the next light source is ended at a latest timing among the timings at which the total of the drive current amounts of the light sources of which the lighting timings are already determined is smallest.

9. The lighting device according to claim 7, wherein
when the lighting period of the next light source is longer than a period in which the total of the drive current amounts of the light sources of which the lighting timings are already determined is smallest, the phase determination unit determines the lighting timing of the next light source such that the next light source is lit also during a period which is one of periods before and after the period in which the total of the drive current amounts of the light sources is smallest, and in which the total of the drive current amounts is smaller.

10. An image display device comprising:
a plurality of light sources corresponding to a plurality of areas of a screen;
a control unit configured to control at least one of a duty ratio between a lighting period and an light-out period and a drive current amount of each of the light sources based on input image data; and
a display unit configured to display an image on a screen by modulating light from the plurality of light sources, wherein
the control unit controls lighting timings of the light sources in accordance with the drive current amounts of the light sources such that a fluctuation of the total of the drive current amounts of the light sources is suppressed.

11. A control method for a lighting device including a plurality of light sources corresponding to a plurality of areas of a screen, comprising the steps of:
controlling at least one of a duty ratio between a lighting period and an light-out period and a drive current amount of each of the light sources based on input image data; and
controlling lighting timings of the light sources in accordance with the drive current amounts of the light sources such that a fluctuation of the total of the drive current amounts of the light sources is suppressed.

12. The control method for a lighting device according to claim 11, further comprising the steps of:
determining a determination order of the lighting timings of the light sources; and
sequentially determining the lighting timings of the light sources based on the determination order and determining the lighting timing of the next light source such that a fluctuation of the total of the drive current amounts of the light sources of which the lighting timings are already determined and the drive current amount of the next light source is suppressed.

13. The control method for a lighting device according to claim 12, wherein
the determination order is determined such that the lighting timing of the light source is determined in descending order of the drive current amount thereof.

14. The control method for a lighting device according to claim 13, wherein
the determination order is determined such that the lighting timing of the light source is determined in descending order of the duty ratio thereof when a plurality of the light sources have an identical drive current amount.

15. The control method for a lighting device according to claim 12, wherein
the drive current amounts of the light sources are classified into a plurality of levels based on a magnitude thereof, and the determination order is determined such that the lighting timing of the light source is determined in descending order of the level of the drive current amount thereof.

16. The control method for a lighting device according to claim 15, wherein
the duty ratios of the light sources are classified into a plurality of levels based on a magnitude thereof, and the determination order is determined such that the lighting timing of the light source is determined in descending order of the level of the duty ratio thereof when a plurality of the light sources belong to an identical level of the duty ratio thereof.

17. The control method for a lighting device according to claim 12, wherein
the lighting timing of the next light source is determined such that the next light source is lit at a timing at which the total of the drive current amounts of the light sources of which the lighting timings are already determined is smallest.

18. The control method for a lighting device according to claim 17, wherein
the lighting timing of the next light source is determined such that lighting of the next light source is started at an earliest timing among the timings at which the total of the drive current amounts of the light sources of which the lighting timings are already determined is smallest, or the lighting of the next light source is ended at a latest timing among the timings at which the total of the drive current amounts of the light sources of which the lighting timings are already determined is smallest.

19. The control method for a lighting device according to claim 17, wherein
when the lighting period of the next light source is longer than a period in which the total of the drive current amounts of the light sources of which the lighting timings are already determined is smallest, the lighting timing of the next light source is determined such that the next light source is lit also during a period which is one of periods before and after the period in which the total of the drive current amounts of the light sources is smallest, and in which the total of the drive current amounts is smaller.
